(19) United States
(12) Patent Application Publication
(10) Pub. No.: US 2006/0178891 A1
(43) Pub. Date: Aug. 10, 2006

(54) Customer assistance system for stores

(76) Inventor: Wolfgang KRATZENBERG, Schauenburg (DE)

Correspondence Address: ABELMAN, FRAYNE & SCHWAB, 666 THIRD AVENUE, 10TH FLOOR, NEW YORK, NY, 10017, US

(21) Appl. No.: 10/549,967

(22) PCT Filed: Mar. 16, 2004
(86) PCT No.: PCT/EP04/02697

§ 371 Date: Sep. 16, 2005

(30) Foreign Application Priority Data
Mar. 18, 2003 (DE) 103 12 026.2
Mar. 31, 2003 (DE) 103 14 349.1

(51) Int. Cl. G06Q 99/00

(52) U.S. Cl. 705/1

(57) ABSTRACT

A customer assistance system for stores with a very large sales area, particularly hypermarkets, as they are called, in which a plurality of information output devices, for example, display panels, which are arranged so as to be distributed over the sales area for outputting information directed to the customers and at least one central computer are provided, which central computer controls the output of information, particularly advertising information, by means of the information output devices, for example, display panels, by means of transmission means and predefinable programs. The customer assistance system comprises at least one touch screen which is placed at the entrance to the sales area for converting the buying desire of the customer into a machine-readable language, shopping carts or shopping baskets outfitted with a passive identification that can be interrogated, a plurality of information output devices, particularly display panels, that are equipped with transmitter/receiver devices, and a central computer for preparing a guidance program for the customer based on the buying desire of the customer and for controlling the display means at the information output devices.

The invention is directed to a customer assistance system for stores with a very large sales area, particularly hypermarkets, as they are called, in accordance with the preamble of claim 1.

Although it is not required, it is nevertheless highly advisable in stores with very large sales surfaces, particularly in hypermarkets, as they are called, to afford assistance to customers which makes it easier for them to make their desired purchases and to spare them from cumbersome searching for the location or storage point of specific goods. Naturally, this does not apply to all goods and all customers of a store, in particular not to foodstuffs for daily requirements, e.g., fruit and vegetables, but is generally desirable. Further, once the customers have entered the sales area, the store has a certain interest in attracting their attention to special offers and in making it easier for them to find the location or storage point of the special offers, as the case may be.

On the other hand, stores are also basically interested in acquiring and evaluating or documenting statistics on typical customer behavior, especially as it relates to a buying desire originally expressed by the customer, if possible preferably with respect to the windfall gains from special offers that actually belong to a range of goods differing from the group of goods that corresponds to the customer's original buying desire. Likewise, the stores are also interested in understanding turnovers in accessories for a customer's original buying desire, for example, battery-powered electrical devices and batteries, or washing machines and detergents, and the like.

Finally, in addition to directing each individual customer along a specific path, there is also a particular interest in displaying general advertising information within the sales area of a store.

Therefore, it is the object of the invention to provide a customer assistance system which ensures in a comparatively economical manner with respect to installation and very economically with respect to maintenance that the customer is reliably guided within the store on the one hand and that the customer behavior and purchasing behavior within the store is acquired and evaluated on the other hand.

Based on a system according to the preamble of claim 1, the above-stated object is met according to the invention in that

a) at least one device containing a touch screen is arranged at the entrance to the sales area in order to allow the customer to designate at least one desired good or group of goods in a machine-readable manner and, at the same time, to request help for finding the position of the associated sales shelf or the associated storage location;

b) every shopping cart and every shopping basket is provided with a passive identity that can be interrogated, in particular a transponder;

c) the device containing the touch screen is outfitted with an interrogating device which is formed by a transmitter/receiver unit for reading into and conveying to the central computer the identification of the transponder of the shopping cart or shopping basket that is carried by the customer operating the touch screen as a temporary identity;

d) a plurality of interrogating devices formed by a transmitter/receiver unit are arranged so as to be distributed over the sales area for detecting the temporary identity of the respective shopping cart or the respective shopping basket;

e) at least some of the interrogating devices formed by a transmitter/receiver unit are arranged at one of the information output devices, particularly display panels;

f) the information output devices or display panels at least with subfields are dedicated to outputting or displaying guide information or route information, e.g., a combination of goods details and directional arrows, for the customer;

g) all interrogating devices and all information output devices formed, respectively, by a transmitter/receiver unit, particularly display panels, are connected to a central computer that is outfitted with evaluating and controlling devices; and

h) the central computer is outfitted with a learning expertise, particularly machine knowledge, suitable for optimal customer assistance.

The chief advantage achieved by the customer assistance system according to the invention consists on the one hand in that the customer is afforded the possibility of requesting an assistance system as soon as he/she enters the sales area of a store, which assistance system directs the customer simply, directly and without difficulty to the location or position of the desired goods, and, on the other hand, consists in that touch screens need only be placed at the entrances to the sales area and, therefore, maintenance and upkeep for the customer assistance system remain low.

Further, by outfitting the central computer with a comparison device, it is possible to track the paths of the customer so that in the event that the customer deviates from the shortest path that has been marked out an alternate route can be offered to the customer which benefits reliable guidance of the customer to his/her destination on the one hand and, on the other hand, increases the possibility that the customer will put other goods in the shopping cart along the way, e.g., goods that are on sale. In other words, the customer is offered the possibility of deviating from the prescribed, direct path to the sought for good, if desired, without losing the general direction.

Further, outfitting the central computer with a device having expertise with respect to related groups of goods, particularly of accessory goods appropriate for a principal good, allows the customer to be guided appropriately also to goods other than the original buying desire, e.g., in that the customer is guided to the exit or to the checkout past stocks of complementary goods.

Further, optimal guidance of the customer through the sales area of the store is made possible in that the central computer is outfitted with a preferably self-learning first device comprising expertise with respect to a general purchasing behavior of customers and a linking device for preparing a guidance program which takes into account suitable, possibly comparable groups of goods or goods empirically found to lie within the area of interest of a customer for a first group of goods.

The customer assistance system according to the invention also offers some advantages for the store management. To begin with, for example, the path tracking system makes it possible to determine and document particular purchasing interests or at least the interests of a customer in special goods which are not included in the current buying desire, for example, goods on sale.

The self-learning expertise can be augmented in this way and prepared or taught for a future arrangement of goods or guidance of customers.

Further, the customer guidance system according to the invention makes it possible to make optimal use of the information output devices, particularly display panels, that are arranged so as to be distributed over the sales area, insofar as they are used for guiding a customer only when the customer must diverge from his/her previous movement direction in order to arrive at the desired group of goods. For periods of time during which no displays are required for guiding a customer, the information output devices, particularly display panels, can be used for general advertising purposes or for announcing special offers. A device is advantageously provided in the central computer which records the times which the information output devices, particularly display panels, are occupied by a standardized or general advertising display for a specific advertiser in the role of client of the store and sums them for subsequent accounting.

A general idea underlying the present invention consists in outfitting customers who have taken a shopping cart or a shopping basket with a temporary identity for a period lasting only for the time spent in the sales area and detecting and documenting the movements and activities of this identity within the sales area and evaluating them for further development of the machine knowledge of the central computer in order to make it possible for the central computer to optimally guide the customer within the sales area.

Of course, the possibilities offered by the expertise of the central computer by means of special devices should also be available for the benefit of the store management.

The invention is described in detail in the following description, which is given by way of example, with reference to an embodiment example shown in the drawing.

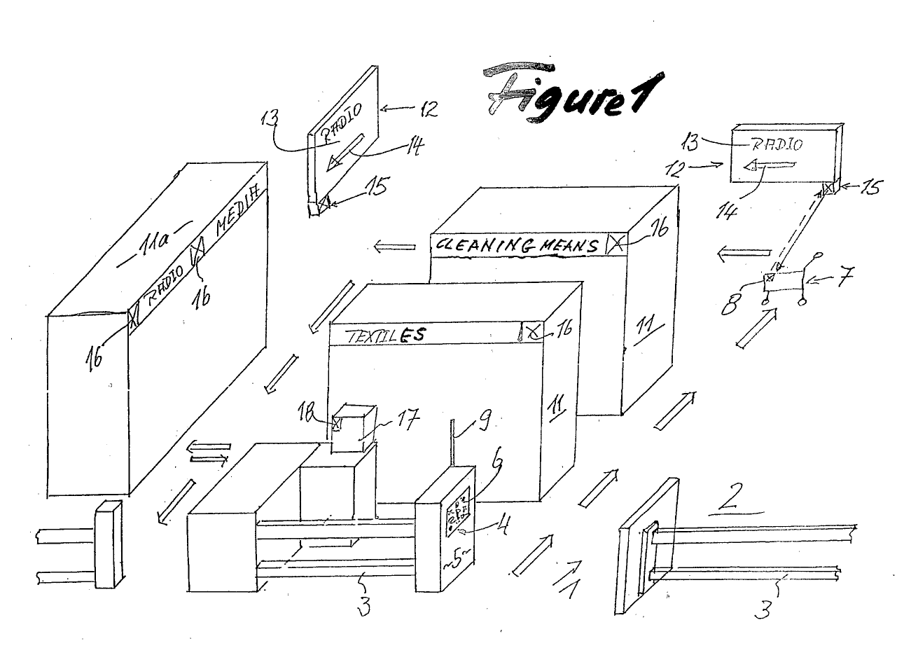

FIG. 1 is a schematic view of a section of a sales area of a store;

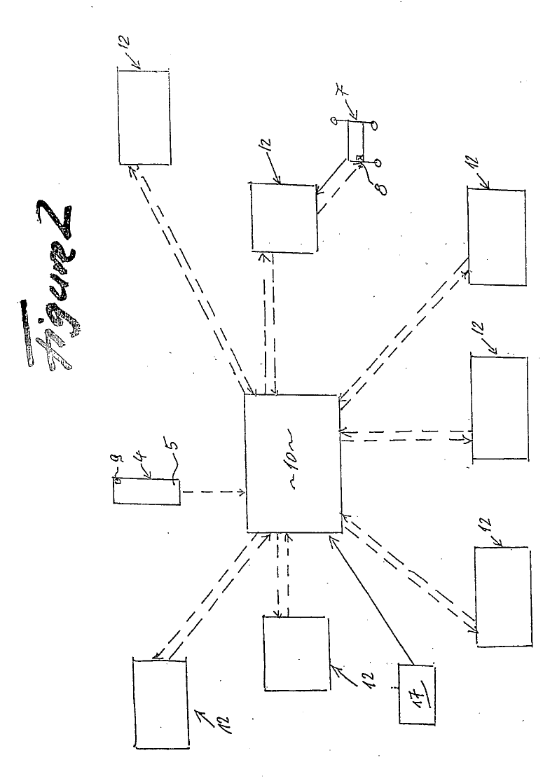

FIG. 2 is a schematic view of the connection of a central computer to a plurality of transmitting/receiving units for detecting and tracking the path of transponders accommodated in shopping carts and shopping baskets and temporary identities formed by these transponders;

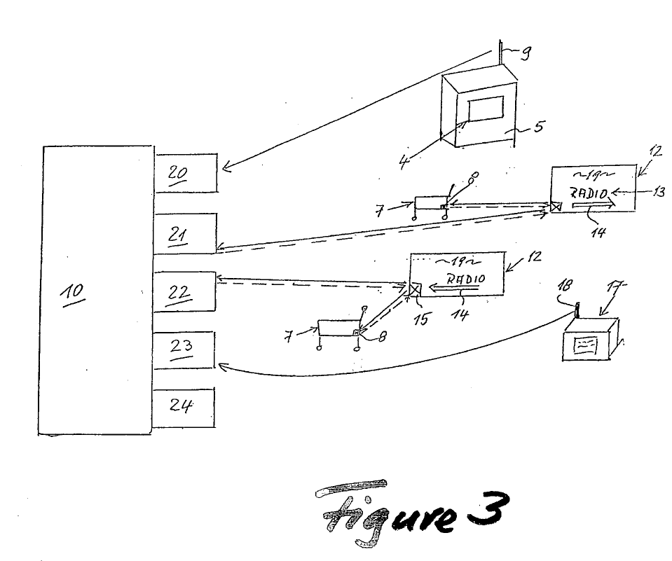

FIG. 3 is a schematic view showing a central computer outfitted with a quantity of devices for evaluating results.

A column 5 carrying a touch screen 4 is arranged at the entrance 1 to a sales area in a store, which sales area is designated generally by 2 and closed off by barriers 3. In the normal position, the touch screen 4 is provided with a quantity of goods identifications, in particular pictograms 6, representing groups of goods offered within the store. In response to the selection of a group of goods by a customer, the touch screen 4 changes its surface in such a way that all of the goods belonging to the selected group of goods are displayed in detail to the customer and the customer now has the possibility of entering specific goods desired by the customer in the touch screen 4. At the same time, all of the shopping carts 7 or shopping baskets of the store are provided with a transponder 8 which outputs a specific, unmistakable identification or temporary identity when interrogated. When entering the sales area 2, the transponder 8 is interrogated by an antenna 9 communicating with the touch screen 4 and a temporary identity of the customer carrying the shopping cart 7 or shopping basket is sent to the central computer 10 of the installation. A plurality of sales shelves 11 in which the goods offered for sale by the store are stocked by groups of goods are arranged so as to be distributed throughout the sales area 2 of the store. The sales shelves 11 are oriented at an angle relative to one another in the arrangement shown in the drawing so that the customer searching for a particular good must change his/her progress one or more times in order to reach that shelf in which the goods desired by the customer are stocked. A quantity of information output devices, particularly display panels 12, which are arranged so as to be distributed over the sales area 2 serve to guide the customer to the sales shelf 11a containing the good desired by him or her, in the present case, a radio. These information output devices, particularly display panels 12, are outfitted with path directing devices, particularly arrows 14 provided with merchandise details 13, e.g., a radio in the present example, which are controllable by the central computer 10 and which show the customer the changes in directions required for finding the desired goods within the sales area 2. At the same time, the display panels are outfitted with first transmitter/receiver units 15 which detect the identification or temporary identity of each transponder 8 arriving in their range and which transmit this identification or temporary identity to the central computer 10 so that the latter can initiate the activation of a directional instruction or, if no change in direction is necessary, can suppress any direction display. At the same time, the individual sales shelves 11 are outfitted with corresponding transmitter/receiver units 16 which can determine the arrival of the customer at the sought for sales shelf 11a and convey this to the central computer 10. Finally, the checkouts 17 to be passed by the shopping cart 7 or shopping basket when exiting the sales area 2 of the store are likewise outfitted with a transmitting/receiving device 18 for detecting the temporary identity of the customer with his/her shopping cart 7. The transmitting/receiving device is simultaneously designed to transmit the itemized total purchase to the central computer 10 so that the central computer 10 is informed about the identity of the customer and the goods purchased by this customer when exiting the sales area 2.

The information output devices, particularly display panels 12, are suitable not only for outputting directional instruction functions but also for displaying general advertising texts and the like over at least the greater portion 19 of their surface, primarily also for producers or suppliers acting as clients of the store. The display of advertising texts or advertising images preferably takes place at times during which directions for a customer are not required.

The central computer 10 is outfitted with a first device 20 which stores and links the buying desire entered on the touch screen 4 by the customer and the temporary identity given by the transponder 8 of the shopping cart 7 or shopping basket carried by the customer. Further, the central computer 10 is outfitted with a second device 21 which is equipped to generate a guidance program for the customer and the temporary identity based on the expertise and customer's desire present in the computer and comprises the means for controlling the displays required for guiding the customer on the information output devices, particularly display panels 12. In the embodiment form, these means control displays 13 and 14 showing arrows and specific directions by means of the transmitter/receiver units 15. At the same time, in order to clarify the direction instructions, the advertising display field 19 of the information output devices, particularly display panels 12, are temporarily stopped or shut down.

Further, the central computer 10 is outfitted with a comparison device 22 which compares the information coming in from the transmitter/receiver units 15 that are arranged so as to be distributed over the sales area 2 concerning the passage of a determined identity past certain points in the sales area 2 to the guide program which is prepared by the second device 21 for a determined customer or a determined identity and generates instruction aids for guiding the customer to his/her destination in case of deviations.

In addition, the central computer 10 is also outfitted with a device 23 which is suitable for detecting and comparing the goods purchased by the customer or temporary identity and paid for at the checkout to the goods selected on the touch screen 4 when entering the sales area 2 and which, further, derives a statistical value for a recurring customer behavior from the results of a plurality of such comparisons and adds to the expertise of the central computer 10.

Further, the central computer 10 is outfitted with an additional device 24 by which the times during which the individual information output devices, particularly display panels 12, are occupied by external advertising or product announcements are determined, registered and summed for an advertising cost account.

1. Customer assistance system for stores with a very large sales area, particularly hypermarkets, as they are called, in which a plurality of information output devices, particularly display panels, which are arranged so as to be distributed over the sales area for outputting information directed to the customers and at least one central computer are provided, wherein the central computer controls the output of information, particularly advertising information, by means of the information output devices, for example, display panels, characterized in that
a) at least one device containing a touch screen is arranged at the entrance to the sales area in order to allow the customer to designate at least one desired good or group of goods in a machine-readable manner and, at the same time, to request help in finding the position of the associated sales shelf or the associated storage location;
b) every shopping cart and every shopping basket is provided with a passive identification which can be interrogated and which form a temporary identity;
c) the device containing the touch screen is outfitted with an interrogating device which is formed by a transmitter/receiver unit for reading into and conveying to the central computer the identification of the shopping cart or shopping basket that is carried by the customer operating the touch screen as a temporary identity;
d) a plurality of interrogating devices each formed by a transmitter/receiver unit are arranged so as to be distributed over the sales area for detecting and reporting on the identification and temporary identity of the respective shopping cart or the respective shopping basket passing through their area;
e) at least some of the interrogating devices formed by a transmitter/receiver unit are arranged at one of the information output devices, particularly display panels, and some of the transmitting/receiver units are arranged at the respective sales shelf;
f) the information output devices, particularly display panels, at least areas thereof are dedicated to outputting or displaying guide information or route information for the customer;
g) all interrogating devices and all information output devices, particularly display panels, that are formed by a transmitter/receiver unit, are connected to a central computer; and
h) the central computer is outfitted with expertise, particularly self-learning machine knowledge, suitable for customer assistance.

2. Customer assistance system according to claim 1, characterized in that every shopping cart and every shopping basket is outfitted with a transponder which sends an unmistakable identification specifically associated with the shopping cart and shopping basket.

3. Customer assistance system according to claim 1, characterized in that a transmitter/receiver unit which interrogates the identification or temporary identity of the transponder arriving in its range and transmits this to the central computer is associated at least with every information output device.

4. Customer assistance system according to claim 1, characterized in that a transmitter/receiver unit is associated at least with every sales shelf, preferably with every group of goods located in a sales shelf, which transmitter/receiver unit interrogates the identification or temporary identity of the shopping carts or shopping baskets entering its range and particularly the transponder arranged at the shopping cart or shopping basket, and transmits this to the central computer.

5. Customer assistance system according to claim 1, characterized in that a transmitter/receiver unit for interrogating the transponder of shopping carts or shopping baskets which arrives in the range of the transmitter/receiver unit or in the range of the checkout is associated with every checkout, which transmitter/receiver unit interrogates the identification or temporary identity of the transponder arriving in its range and transmits this to the central computer together with the itemized goods.

6. Customer assistance system according to claim 1, characterized in that the display panels forming the information output devices contain directional information displays, particularly word reproductions and directional arrows, which relate to goods and which are controlled by the central computer.

7. Customer assistance system according to claim 1, characterized in that the information output devices are formed by illuminated panels which are controlled by the central computer so as to display advertising notices until a shopping cart or shopping basket whose identification or temporary identity makes it necessary to provide customer information, particularly directional information, arrives in the range of the associated transmitting/receiver unit that is suitable for interrogating the identification.

8. Customer assistance system according to claim 1, characterized in that, at least preferably, an advertisement relating to a product desired by the customer or to the product group desired by the customer is displayed on the display panels forming the information output devices in connection with directional information for the customer.

9. Customer assistance system according to claim 1, characterized in that the central computer is outfitted with a device for storing and linking the buying desire entered on the touch screen by the customer and the temporary identity of the customer given by the transponder of the shopping cart or shopping basket carried by the customer, and in that the central computer is further outfitted with a device for generating a guidance program and for controlling the displays on the information output devices, which displays are required for handling the guidance program.

10. Customer assistance system according to claim 1, characterized in that the central computer is outfitted with a comparison device which compares the guidance program prepared on the basis of the request entered by the customer to the customer's actual path through the sales area and, if required, i.e., in the event that the path of the customer deviates from the determined guidance program, generates the display of correction instructions, particularly detour instructions, on the information output devices located in the estimated continued path of the customer.

11. Customer assistance system according to claim 1, characterized in that the central computer is outfitted with a device that provides expertise with respect to related groups of goods, particularly of accessory goods appropriate for a principal good.

12. Customer assistance system according to claim 1, characterized in that the central computer is outfitted with expertise with respect to a general purchasing behavior of customers and a linking device for preparing a guidance program which takes into account suitable, possibly comparable groups of goods or goods empirically found to lie within the area of interest of a customer interested in a first good or group of goods.

13. Customer assistance system according to claim 1, characterized in that the central computer is outfitted with a device for documenting the buying desire that is entered, for tracking, and for detecting the purchased items of every customer that can be identified by a transponder.

14. Customer assistance system according to claim 1, characterized in that the central computer is outfitted with an interpolating device for determining a characteristic customer behavior which deviates at least partially in relation to the buying desire that is originally entered.

15. Customer assistance system according to claim 1, characterized in that the central computer is outfitted with additional devices for statistical evaluation of more or less typical customer behaviors.

16. Customer assistance system according to claim 1, characterized in that the central computer is outfitted with additional devices for preparing a machine knowledge in a self-learning manner.

17. Customer assistance system according to claim 1, characterized in that a device is provided in the central computer which records the times during which the information output devices, particularly display panels, are occupied by a standardized or general advertising display for a specific advertiser in the role of client of the store and sums them for subsequent accounting.

18. Customer assistance system according to claim 1, characterized in that the touch screens arranged at the entrance or entrances to the sales area each have a surface which is divided into groups of goods and which is switched to a second surface when a group of goods is typed in, which second surface shows in detail all goods of the selected group of goods, and it is accordingly possible for the customer to enter specific goods in a simple manner.
